(19) United States
(12) Patent Application Publication
(10) Pub. No.: US 2018/0193875 A1
(43) Pub. Date: Jul. 12, 2018

(54) Fiber Structure For Paint Roller

(71) Applicant: Maru-T Ohtsuka Corp., Shinjuku-ku, Tokyo (JP)

(72) Inventors: Tatsunari Hougi, Tokyo (JP); Mikimasa Matsuoka, Ito-gun Wakayama (JP); Toshio Takia, Osaka (JP)

(21) Appl. No.: 15/738,543

(22) PCT Filed: Jul. 28, 2016
(86) PCT No.: PCT/JP2016/072116

§ 371 Date: Dec. 20, 2017

(30) Foreign Application Priority Data
Sep. 11, 2015 (JP) 2015-179718

(51) Int. Cl. B05C 17/02; D03D 27/18

(52) U.S. Cl. CPC B05C 17/0207; D02G 3/36; D03D 27/18

(57) ABSTRACT

A fiber structure 5 for a paint roller, which is wound around a roller core, having a ground weave 8; and a pile portion 9 standing from one side of the ground weave. The pile portion 9 includes covered yarn 10 that is formed by winding sheath yarns 12, 13 around a core thread 11, in order to enhance the stiffness of the pile portion 9.

### TECHNICAL FIELD

This invention relates to a fiber structure for a paint roller.

### BACKGROUND ART

Paint rollers with pile fabric wound around a roller core are conventionally known. The pile fabric includes a ground weave that is formed of a textile or knit fabric, and a pile portion. The pile portion is structure together with the ground weave but is formed of another yarns projecting from the surface of the ground weave.

For use of the paint roller, the outermost pile fabric is impregnated with a coating material. If the pile lies, this may cause a decrease in the amount of coating-material soaking or may render the top ends of the pile portion unable to reach the asperities on a to-be-coated surface, which may possibly make uniform coating impossible.

For this reason, maintaining the standing characteristics of the pile portion in the pile fabric for use in the painting roller is very critical to ensuring the coating work efficiency and the coating quality.

Further, the stiffness of the pile portion is required to be increased up to a point in order to maintain the standing characteristics of the pile portion. For that purpose, the pile portion may include twisted yarns. By twisting together a plurality of spun yarns or long fibers, the twisted yarns can be structured to have a higher stiffness than simple spun yarns.

### CITATION LIST

### Patent Literature

Patent Literature 1: Japanese Patent Application No. 2002-001200
Patent Literature 2: Japanese Unexamined Patent Publication No. 2014-237068

### SUMMARY OF INVENTION

### Technical Problem

In the pile fabric for use in conventional paint rollers, the pile portion consisting of twisted yarns stands on the ground weave.

FIG. 6 is an enlarged view of a typical twisted yarn 1. The twisted yarn 1 is made by intertwisting a thread 2 and a thread 3 around the center axis of the twisted yarn 1 in the direction of arrow A. Each of the threads 2, 3 consisting of the twisted yarn 1 is also a twisted yarn that is obtained by twisting together two spun yarns. The twist direction of each thread 2, 3 is the direction of arrow B opposite to the direction of arrow A which is the twist direction of the twisted yarn 1. However, this is the same when the threads 2, 3 are simple spun yarns rather than twisted yarns.

The twisted yarn 1 structured as described above is acted upon by a force in the direction of untwisting, that is, the B direction opposite to the direction of arrow A. For this reason, the pile portion standing on the ground weave has a habit of being acted upon by the force in the direction of untwisting the twisted yarn 1, so that the overall pile portion has a tendency to tilt in the direction of its habit.

Thus, the pile fabric, which has been impregnated with a coating material, is pressed against the to-be-coated surface, whereupon the pile portion lies easily in the direction of the habit.

Then, once the pile portion lies, the pile portion comes into intimate close to the ground weave due to the viscosity of the coating material. This lying state is maintained to cause the pile portion to be hard to stand. In particular, where the coating material exhibits a high viscosity, there is little return to the standing state.

In the paint roller with the lying pile portion as described above, the space within the pile portion is compressed, so that even if the paint roller is re-impregnated with the coating material, the amount of coating-material soaking is reduced. Because of this, a single impregnation with the coating material soon causes a lack of the coating material during the process of coating work. A lack of the coating material may lighten the color of a coating, or may cause fading. To avoid this, during the process of caring work, the paint roller is required to be repeatedly dipped into the coating material, and therefore there is a disadvantageous problem of low working efficiency.

Further, while the pile portion lies, the top end of the pile portion is out of contact with the to-be-coated surface, so that the coating material does not reach the pits in the to-be-coated surface, which may possibly cause coating irregularities or an uncoated area.

If the paint roller with the lying pile portion as described above is used to attempt to coat inside of the pits perfectly, the roller is required to be strongly pressed against the to-be-coated surface or is required to hold a more amount of soaking than necessary.

The stronger the roller is pressed against the to-be-coated surface, the more the worker is fatigued.

Further, if the pile fabric is attempted to hold plenty of coating material more than necessary in order that the coating material spreads into the pits without a strong pressing force, the coating material may dip from the paint roller to make the surrounding area dirty.

At all events, in the paint roller using the conventional pile fabric as described above, the standing characteristics of the pile portion cannot be maintained. Accordingly, there is a disadvantageous problem of low coating work efficiency.

It is an object of the present invention to provide a fiber structure for a paint roller which offers enhanced coating work efficiency by improving the standing characteristics of a pile portion to maintain a standing state of the pile portion or to allow the pile portion to recover from its lying position, even when, for example, a high-viscosity coating material is used.

### Solution to Problem

A first invention has a feature that a fiber structure for a paint roller, which is wound around a roller core, includes: a ground weave; and a pile portion including covered yarn and standing from one side of the ground weave.

A second invention has a feature that the covered yarn is formed by winding sheath yarn around a core thread in two or more layers.

A third invention has a feature that the pile portion includes cut pile.

### Advantageous Effects of Invention

According to the invention, the stiffness of the pile portion is increased to improve the stating characteristics of the pile portion. Therefore, in a paint roller using the fiber structure according to the present invention, the pile portion does not easily lie during the process of using the paint roller, so that the standing state can be maintained at all times. Accordingly, the top end of the pile portion easily enters pits at coating, thus achieving stable coating even on a to-be-coated surface having asperities.

Further, because the pile portion keeps the standing state during the process of use, there is no occurrence of any disadvantage such as that the amount of soaking cannot be ensured due to the lying pile as happens conventionally, so that a target amount of soaking is able to be constantly maintained. Thus, it is possible to realize stable coatings at all times in terms of a constant operation amount of the paint roller or a constant pressing force against the to-be-coated surface.

Further, a shortage of the amount of soaking involves a plurality of repetitions of soaking of the coating material during the coating work operation or involves a need for strong pressing against the to-be-coated surface. This decreases the working efficiency. However, such a disadvantageous problem is not produced in the present invention.

Further, because of no necessity for soaking of a greater amount of coating material than required, this eliminates a situation in which the coating material falling in drops from the paint roller to make the surrounding area dirty.

According to the second invention, the sheath yarn wound in two or more layers supports the core thread for further enhancement in stiffness of the covered yarn. Because of this, the standing characteristics of the pile portion are able to be further improved.

According to the third invention, because the top end of the pile portion is able to be thinned, the top end of the pile portion readily enters small pits. Accordingly, the paint roller using the fiber structure according to the present invention is capable of applying greater even and looking coats to the to-be-coated surface with asperities with working efficiency.

Typically, the loop pile has higher standing characteristics than that of the cut pile, but the top end of the loop pile is not easily thinned. In the invention, the pile portion is formed of the covered yarn. As a result, the required standing characteristics is able to be recognized even for the cut pile that has the top end capable of being thinned.

That is, the top end of the pile portion is capable of being thinned while the standing characteristics are maintained, and the paint roller using such a fiber structure enables sophisticatedly and evenly coating.

### BRIEF DESCRIPTION OF DRAWINGS

FIG. 1 is a perspective view of the external appearance of a paint roller using a fiber structure according to an embodiment of the present invention.

FIG. 2 is an enlarged view of a covered yarn included in a pile portion according to the embodiment.

FIG. 3 is a table showing kinds of pile portions of the fiber structure used in coating tests.

FIG. 4 shows photographs illustrating conclusions of the coating tests on the paint roller using the fiber structure according to the embodiment.

FIG. 5 shows photographs illustrating conclusions of the coating tests on a paint roller using a conventional fiber structure.

FIG. 6 is an enlarged view of a twisted yarn.

### DESCRIPTION OF EMBODIMENTS

An embodiment according to the present invention will now be described.

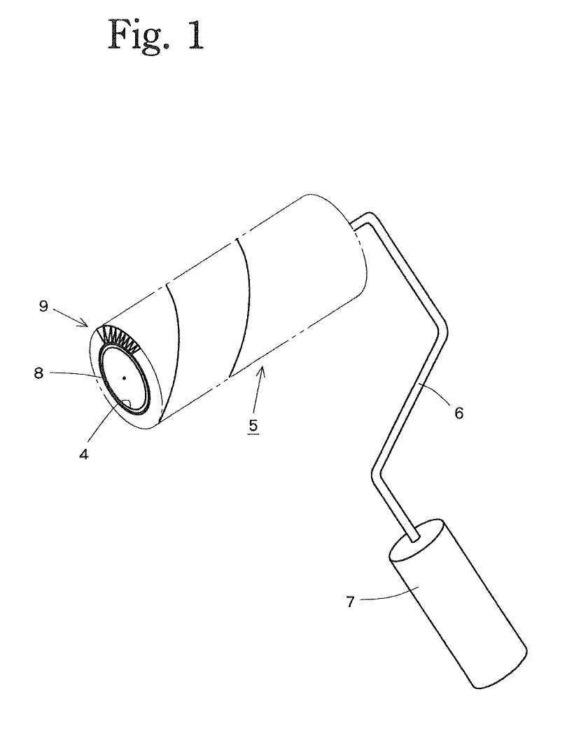

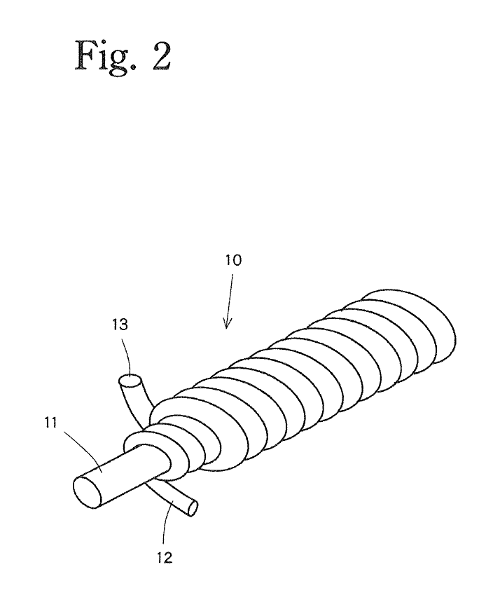

Regarding a fiber structure for a paint roller according to the embodiment, as illustrated in FIG. 1 and FIG. 2, a pile fabric 5 which is a fiber structure according to the present invention is wound around and bonded to the outer periphery of a roller core 4, and a roller frame 6 is attached to the roller core 4. The roller frame 6 supports rotatably the roller core 4, and includes a handle 7 at the opposite end to the roller core 4, the handle 7 being gripped by a worker during the coating work.

The pile fabric 5 includes a pile portion 9 standing on a ground weave 8, and the pile portion 9 consists of covered yarn 10 illustrated in FIG. 2. It is noted that a typical method of manufacturing pile fabrics is employed as a method of forming the ground weave 8 and the pile portion 9 of the pile fabric 5.

Further, the covered yarn 10 is formed by winding a first sheath yarn 12 around the outer periphery of a core thread 11, and then winding a second sheath yarn 13 around the outer periphery of the wound first sheath yarn 12 in the winding direction opposite to the winding direction of the first sheath yarn 12. The core thread 11 and the sheath yarns 12, 13 are twisted yarns, but the yarns may be formed of non-twisted long fibers, spun yarn, and/or the like.

The covered yarn 10 has a stiffness increased by winding the first and second sheath yarns 12, 13 on the core thread 11, and the standing characteristics of the pile portion 9 including such a covered yarn 10 is enhanced. Further, unlike twisted yarns, the covered yarn 10 has little habit such as of tending to tilt in a particular direction from the beginning.

In this manner, because the covered yarn 10 maintains the standing characteristics by causing the sheath yarns 12, 13 to support the standing state of the core thread 11, the covered yarn 10 has a high stiffness, and therefore, for example, even if the covered yarn 10 is tilted by being pressed against the to-be-coated surface, the covered yarn 10 is capable of being returned to the standing state. In particular, because of double winding of the sheath yarns 12, 13, the covered yarn 10 according to the embodiment has a greater effect of improving the standing characteristics of the pile portion 9 by the core thread 11 being supported by the sheath yarns 12, 13. However, the sheath yarn may be wound in only one layer or three or more layers, and the number of winding layers may be selected on an as-needed basis depending on required characteristics.

It is noted that, in the embodiment, the core thread 11 and the sheath yarns 12, 13 are made from polyester, and the diameter of the sheath yarn 12, 13 is smaller than that of the core thread 11.

Further, the characteristics of the covered yarn 10 are able to be varied depending on winding pitch of the sheath yarn 12, 13. The smaller pitch the winding pitch of the sheath yarn 12, 13 is wound with, the stronger the force of the sheath yarn 12, 13 supporting the core thread 10, thus maintaining the standing characteristics of the core thread 10.

Further, if the inner sheath yarn 12 is different in winding pitch from the outer sheath yarn 13, this enables, depending on a combination of the yarns 12, 13, fine adjustments of the stiffness of the covered yarn 10 and the standing characteristics of the pile portion 9.

However, the standing characteristics of the pile portion 9 are changed by material properties and/or a diameter of each yarn 11, 12, 13, and or the like, as well as the pitch of the sheath yarn. The material properties, the diameter, the sheath-yarn winding pitch and/or the like maybe selected in accordance with characteristics, such as stiffness and the like, required of the pile fabric 5 for the paint roller. The same applies to the case where the sheath yarn is wound in one layer or three or more layers.

It is noted that the sheath yarn may be thicker than the core thread 10.

Coating tests have been conducted for confirmation of the performance of the paint roller using the pile fabric 5 according to the embodiment. The coating tests will be described below.

For the coating tests, two types of paint rollers using the pile fabric 5 according to the embodiment and three types of paint rollers using a pile fabric corresponding to one described in the related art example are used to coat white wall surfaces as tests 1 to 5.

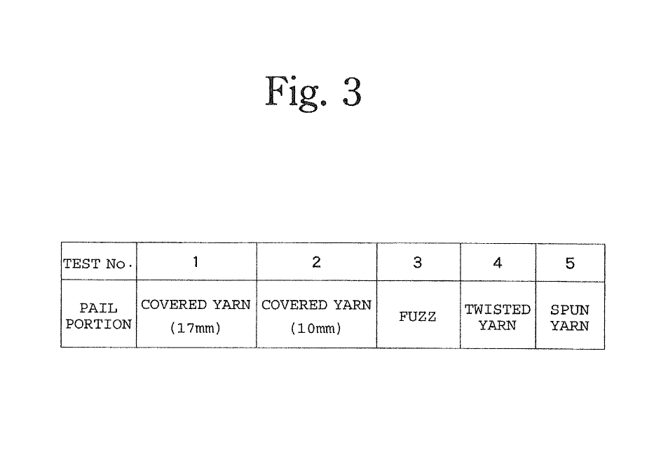

The pile portions of the pile fabrics used in the paint rollers in the tests 1 to 5 are shown in FIG. 3. Specifically, a covered yarn of a length of about 17 (mm) is used in the pile portion of the paint roller used in the test 1, while a covered yarn of a length of about 10 (mm) is used in the pile portion of the paint roller used in the test 2.

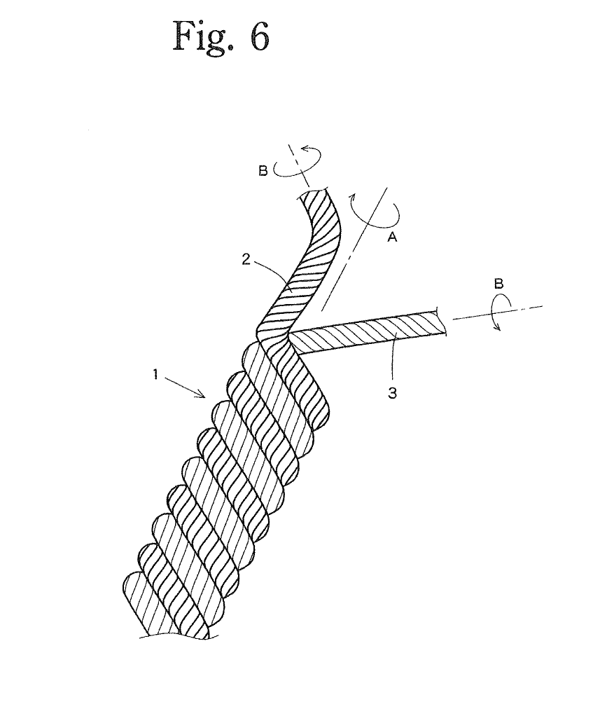

Further, a fuzzy yarn is used for the pile portion of the paint roller used in the test 3. The twisted yarn 1 as illustrated in FIG. 6 is used for the pile portion of the paint roller used in the test 4. And, a spun yarn is used for the pile portion of the paint roller used in the test 5.

The fuzzy yarn in the test 3 refers to a fluffed yarn into which short fibers are spun, and a method of manufacturing pile fabric is the same as other pile fabrics. However, the pile portion formed of this fuzzy yarn takes a spongy form with continuously linking flue.

And, the pile portions in the tests 3 to 5 have a height of about 10 (mm) in pre-use conditions.

Further, each of the pile portions is cut pile having a top end cut.

The following is a test method.

In each test, a roller, which is impregnated with coating material with a later-described method, was used to coat a white wall surface with asperities. Then, the coated conditions were visually compared with one another.

The coating material used is “333 Regal Semi-Gloss 481G, #2065-20 (royal blue)” manufactured by Benjamin Moore. The coating material provides water resistance for external walls, and has a relatively high viscosity.

In each test, the paint roller was soaked in the coating material within a vat containing the coating material, and the paint roller was rolled back and forth 10 times on the bottom and side faces of the vat in order for the coating material to soak into the surface of the roller core 4 (see FIG. 1). After that, to the extent that the coating material does not fall in drops, a net mounted in the vat was used to squeeze slightly out excess coating material.

The roller impregnated with the coating material as described above was used to coat a predetermined area on the wall surface. Specifically, while being moved in both the up and down directions, the paint roller is moved toward the right from the left end of the area as seen the front of the area, to apply coating.

Then, all the above-described tests 1 to 5 were conducted by the same person equally applying a pressing force.

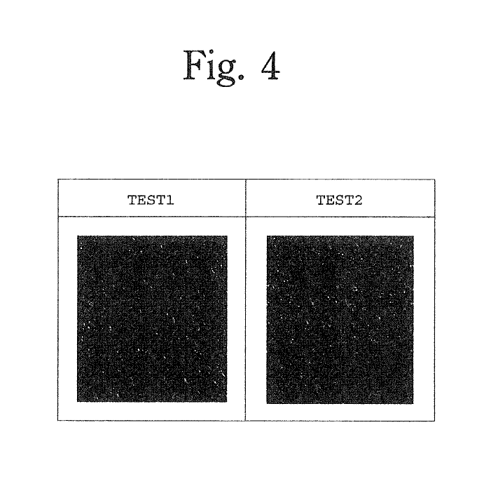

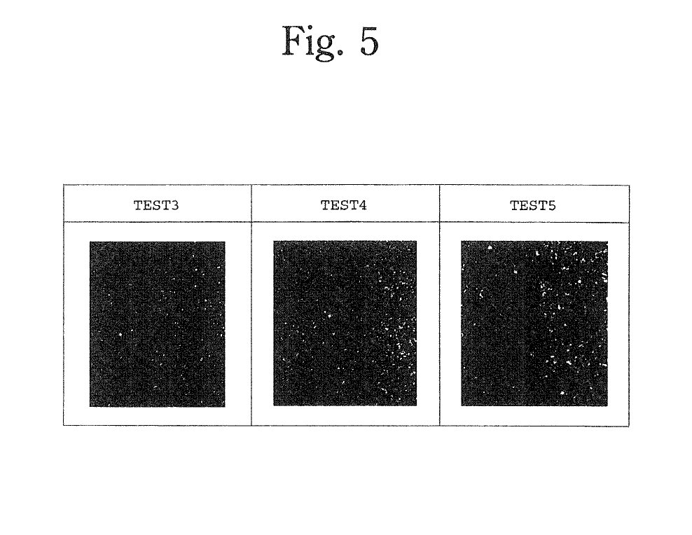

The conclusions of the tests are shown in FIGS. 4, 5.

FIG. 4 is photographs of the wall surfaces after being coated in the tests 1, 2 by use of the paint rollers using the pile fabrics in accordance with the embodiment. FIG. 5 is photographs of the wall surfaces after being coated in the tests 3, 4, 5 by use of the paint rollers using the conventional pile fabrics.

And, it has been seen that, in the tests 1, 2 in which the pile fabrics in accordance with the embodiment were used, the wall surface with asperities was evenly covered with a coating. That is, it has been confirmed that, even if a coating material having a high viscosity to provide water resistance is used, using the pile fabric 5 with the pile portion 9 consisting of the covered yarn 10 enables maintaining the standing characteristics of the pile portion 9, and also enables allowing the top end of the pile portion 9 to reach the pits in the wall surface, so that the insides of the pits are able to be also coated evenly.

Further, because the standing characteristics of the pile portion 9 are maintained, the top end of the pile portion 9 is able to be brought into contact with the pits. And also, because of a sufficient amount of coating-material soaking, the pits are able to be evenly coated even if the paint roller is not strongly pressed against the to-be-coated surface. As a result, a coating worker will not fatigued as happens conventionally, and also a reduction in the number of times the coating material soaks is possible, offering enhanced working efficiency.

In addition, because there is no need to cause the pile portion 9 to hold more coating material than necessary at once, the coating material falling in drops does not make the surrounding area dirty.

On the other hand, in the test 3, the overall to-be-coated area is not coated with the coating material and there remain small white points (see FIG. 5). The white regions are regions corresponding to especially deep pits of the asperities on the wall surface.

The pile fabric used in the test 3 has the pile portion consisting of fuzzy yarn, and has a spongy surface. Because of this, a surface contact is made, from the beginning, with the wall surface which is the to-be-coated surface. It is deemed that, because the top end of the planar pile portion is incapable of making an entry into the bottoms of the deep pits, there remain the white uncoated regions as small points.

In the test 4 on the paint roller including the pile portion with the twisted yarn 1 shown in FIG. 5, there remain many white uncoated points. It is seen that many white points are in, in particular, a right portion corresponding to the latter half of the coating work process. Also, FIG. 5 shows unclearly, but actually, the coating of the right portion within the to-be-coated area was entirely thinner in color than that of the left portion, through which the white color of the wall surface could be seen.

In the test 4, it has been confirmed that not only the standing characteristics of the pile portion consisting of the twisted yarn 1 was poor and a coating failure occurred in the pits, but also the amount of coating material lacked in the latter half of the coating work process.

As a cause of a coating-material shortage in the latter half, two reasons can be considered, one of the reason being that a sufficient amount of coating material was not able to be contained from the beginning, the other being that the pile portion has lain and therefore much of the coating material was supplied in the first half of the coating work process. It can be also considered that both the reasons, not only one of the reasons, may be causes.

Assuming that, from the beginning, a sufficient amount of soaking was incapable of being held, it can be considered that, while the paint roller rolled in the coating-material vat, the pile portion started lying, so that holding the standing state was made impossible by the high-viscosity coating material, thereby to cause a loss of space for holding the coating material.

It also can be considered that the amount of soaking was sufficient in an early stage, but the pile portion lain in the first half of the coating work process, and at this time a large amount of coating material was discharged, so that the coating material was lacked in the latter half.

In all cases, in the latter half of the coating work process, a majority of the pile portion consisting of the twisted yarn 1 lies. Because of this, the uncoated portions of the pits are further increased.

In the test 5, as in the case of the test 4, in the latter half of the coating work process, in particular, the white uncoated regions are increased, and also small thickness of the coating due to a coating-material shortage occurs.

It has been confirmed from this that the pile portion consisting of the spun yarn is also difficult to maintain its standing characteristic, and therefore, when the pile fabric including such a pile portion is used in the paint roller, coating irregularities or an uncoated area are caused.

Accordingly, in order to use the paint rollers in the tests 3 to 5 to coat the pits without having any uncoated region, the force of pressing against the to-be-coated surface is required to be increased as compared with the use of the paint roller using the pile fabric 5 in accordance with embodiment.

It is noted that the pile portion of the pile fabric used in each of the above tests 1 to 5 is cut pile.

Typically, the loop pile can be designed to have a higher stiffness to facilitate maintaining the standing state as compared with the cut pile, but the top end of the loop shape is difficult to be thinned. Because of this, the top end of the loop pile may not enter the small pits, and therefore uncoated pits may possibly be produced.

In other words, in the embodiment, using the pile portion consisting of the covered yarn enables maintaining the stiffness of even the cut pile to enhance the standing characteristics, and simultaneously, enables effective use of the advantage of the microstructures of the top end of the cut pile to allow for narrow and deep pits.

However, depending on applications, the loop pile may be used for the pile portion consisting of the covered yarn. Use of the covered yarn can improve the standing characteristics even if the pile portion is either the cut pile or the loop pile.

### INDUSTRIAL APPLICABILITY

The fiber structure according to this invention is of high usefulness in being used for a paint roller for coating a to-be-coated surface having asperities with, particularly, a high-viscosity coating material.

### REFERENCE SIGNS LIST

4 Roller core
5 Pile fabric
8 Ground weave
9 Pile portion
10 Covered yarn
11 Core thread
12 Sheath yarn
13 Sheath yarn

1. A fiber structure for a paint roller, wound around a roller core, comprising:
a ground weave; and
a pile portion that includes covered yarn standing from one side of the ground weave.

2. The fiber structure of a paint roller according to claim 1, wherein the covered yarn is formed by winding sheath yarn around core thread in two or more layers.

3. The fiber structure of a paint roller according to claim 1, wherein the pile portion includes cut pile.

4. The fiber structure of a paint roller according to claim 2, wherein the pile portion includes cut pile.
